(19) United States
(12) Patent Application Publication
(10) Pub. No.: US 2023/0300860 A1
(43) Pub. Date: Sep. 21, 2023

(54) UNIFORM RESOURCE LOCATOR INDICATING PARAMETERS FOR RECEPTION OF A SERVICE ANNOUNCEMENT FOR A RECEIVE ONLY MODE SERVICE

(71) Applicant: QUALCOMM Incorporated, San Diego, CA (US)

(72) Inventors: Thomas STOCKHAMMER, Bergen (DE); Imed BOUAZIZI, Frisco, TX (US); Charles Nung LO, San Diego, CA (US); Alberto RICO ALVARINO, San Diego, CA (US); Amer CATOVIC, San Diego, CA (US); Miguel GRIOT, La Jolla, CA (US); Ralph Akram GHOLMIEH, San Diego, CA (US)

(21) Appl. No.: 18/162,145

(22) Filed: Jan. 31, 2023

Related U.S. Application Data
(60) Provisional application No. 63/267,689, filed on Feb. 8, 2022.

(51) Int. Cl. H04W 72/30; H04W 76/40; H04L 12/18

(52) U.S. Cl. CPC H04W 72/30; H04L 12/189; H04W 76/40

(57) ABSTRACT

Various aspects of the present disclosure generally relate to wireless communication. In some aspects, a user equipment (UE) may obtain an indication of a uniform resource locator (URL) associated with user service access information for accessing a receive only mode (ROM) service. The UE may receive, based at least in part on the user service access information, a service announcement associated with the receive only mode service. Numerous other aspects are described.

### CROSS-REFERENCE TO RELATED APPLICATION

This Patent Application claims priority to U.S. Provisional Pat. Application No. 63/267,689, filed on Feb. 8, 2022, entitled “UNIFORM RESOURCE LOCATOR INDICATING PARAMETERS FOR RECEPTION OF A SERVICE ANNOUNCEMENT FOR A RECEIVE ONLY MODE SERVICE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for using a uniform resource locator indicating parameters for reception of a service announcement for a receive only mode service.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include obtaining an indication of a uniform resource locator (URL) associated with user service access information for accessing a receive only mode (ROM) service. The method may include receiving, based at least in part on the user service access information, a service announcement associated with the receive only media service.

Some aspects described herein relate to a method of wireless communication performed by a network node. The method may include providing an indication of a URL associated with user service access information for accessing a ROM service. The method may include transmitting, based at least in part on the user service access information, a service announcement associated with the receive only media service.

Some aspects described herein relate to a UE for wireless communication. The UE may include a memory and one or more processors coupled to the memory. The one or more processors may be configured to obtain an indication of a URL associated with user service access information for accessing a ROM service. The one or more processors may be configured to receive, based at least in part on the user service access information, a service announcement associated with the receive only media service.

Some aspects described herein relate to a network node for wireless communication. The network node may include a memory and one or more processors coupled to the memory. The one or more processors may be configured to provide an indication of a URL associated with user service access information for accessing a ROM service. The one or more processors may be configured to transmit, based at least in part on the user service access information, a service announcement associated with the receive only media service.

Some aspects described herein relate to a non-transitory computer-readable medium that stores a set of instructions for wireless communication by a UE. The set of instructions, when executed by one or more processors of the UE, may cause the UE to obtain an indication of a URL associated with user service access information for accessing a ROM service. The set of instructions, when executed by one or more processors of the UE, may cause the UE to receive, based at least in part on the user service access information, a service announcement associated with the receive only media service.

Some aspects described herein relate to a non-transitory computer-readable medium that stores a set of instructions for wireless communication by a network node. The set of instructions, when executed by one or more processors of the network node, may cause the network node to provide an indication of a URL associated with user service access information for accessing a ROM service. The set of instructions, when executed by one or more processors of the network node, may cause the network node to transmit, based at least in part on the user service access information, a service announcement associated with the receive only media service.

Some aspects described herein relate to an apparatus for wireless communication. The apparatus may include means for obtaining an indication of a URL associated with user service access information for accessing a ROM service. The apparatus may include means for receiving, based at least in part on the user service access information, a service announcement associated with the receive only media service.

Some aspects described herein relate to an apparatus for wireless communication. The apparatus may include means for providing an indication of a URL associated with user service access information for accessing a ROM service. The apparatus may include means for transmitting, based at least in part on the user service access information, a service announcement associated with the receive only media service.

Aspects generally include a method, apparatus, system, computer program product, non-transitory computer-readable medium, user equipment, base station, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of accessing a read only media (ROM) service, in accordance with the present disclosure.

FIG. 4 is a diagram illustrating an example associated with using a uniform resource locator (URL) indicating parameters for reception of a service announcement for a ROM service, in accordance with the present disclosure.

FIGS. 5-6 are diagrams illustrating example processes associated with using a URL indicating parameters for reception of a service announcement for a ROM service, in accordance with the present disclosure.

FIGS. 7-8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

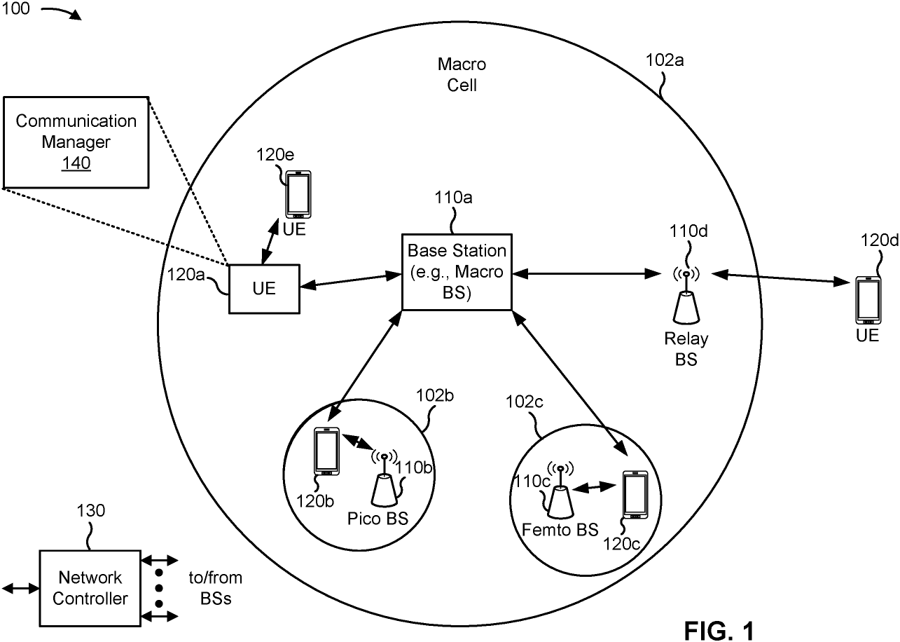

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120 and/or other network nodes. A base station 110 (sometimes referred to as a BS) may include, for example, an NR base station, a high tower high power TV transmitter, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5GNR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may obtain an indication of a uniform resource locator (URL) associated with user service access information for accessing a ROM service; and receive, based at least in part on the user service access information, a service announcement associated with the receive only media service. Additionally, or alternatively, the communication manager 140 may perform one or more other operations described herein.

In some aspects, the base station 110 may include a communication manager 150. As described in more detail elsewhere herein, the communication manager 150 may provide an indication of a URL associated with user service access information for accessing a ROM service; and transmit, based at least in part on the user service access information, a service announcement associated with the receive only media service. Additionally, or alternatively, the communication manager 150 may perform one or more other operations described herein.

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

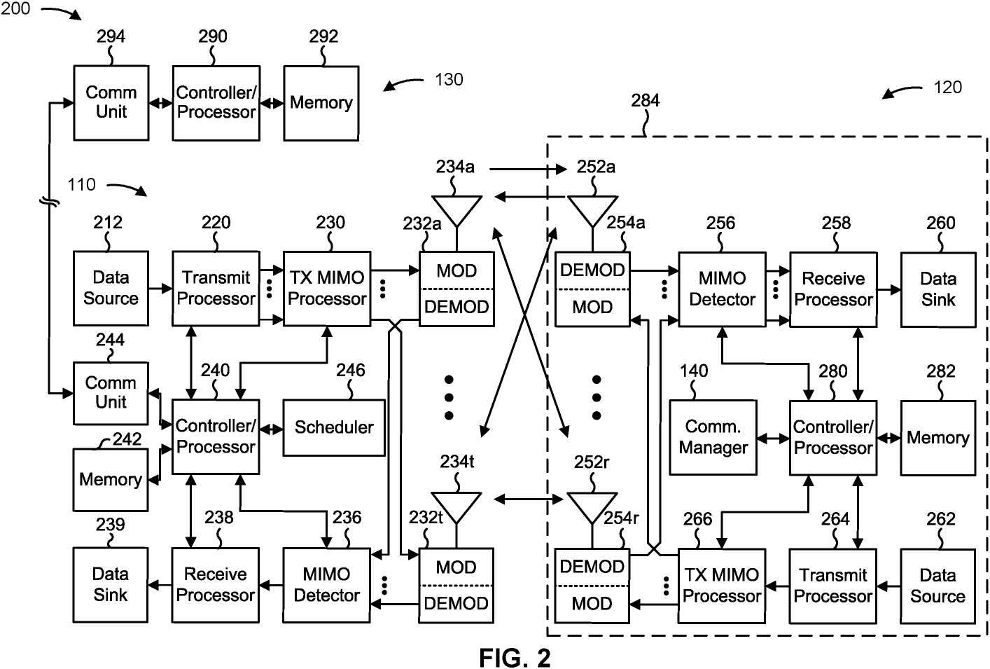

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T ≥ 1). The UE 120 may be equipped with a set of antennas 252a through 252r, such as R antennas (R ≥ 1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

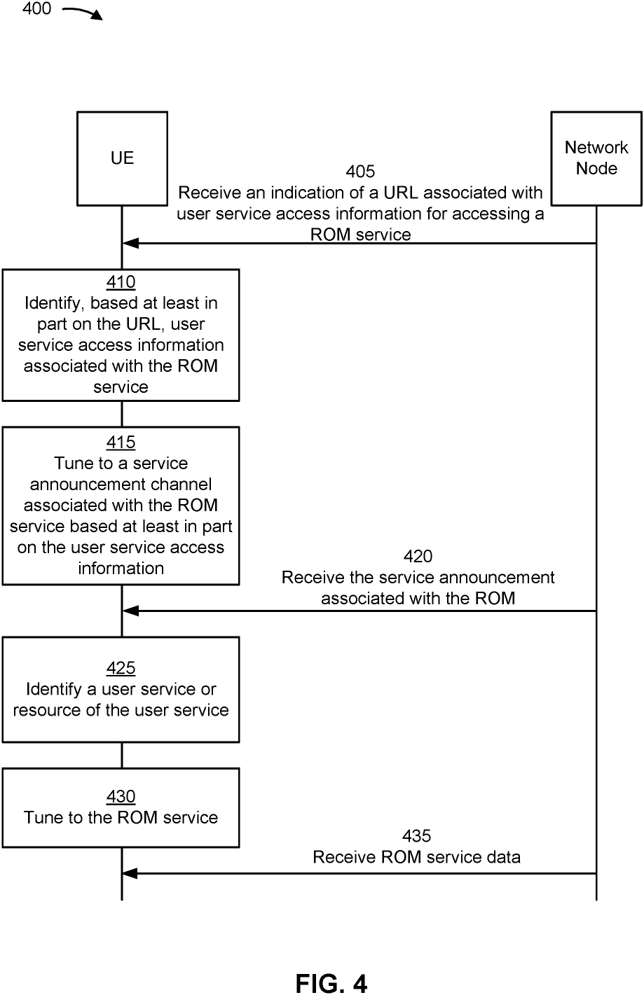

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

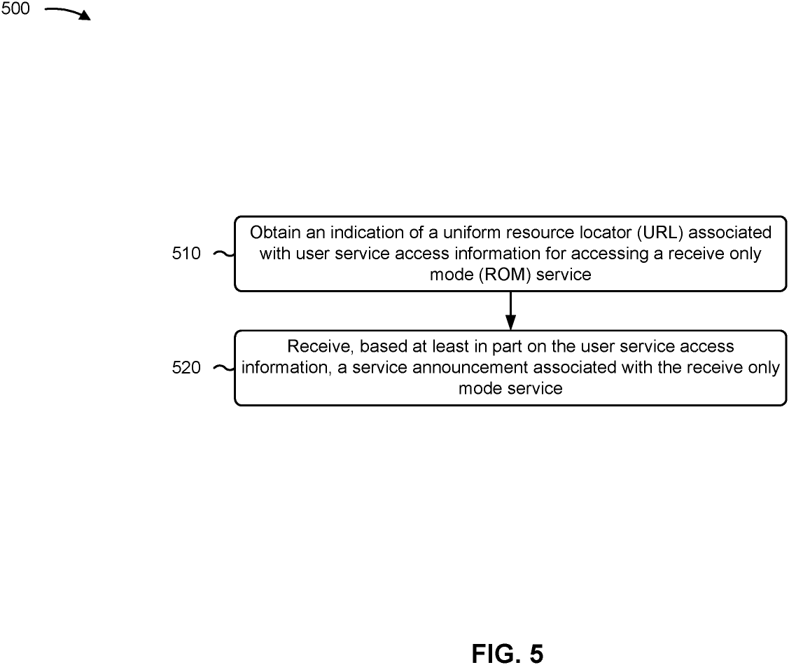

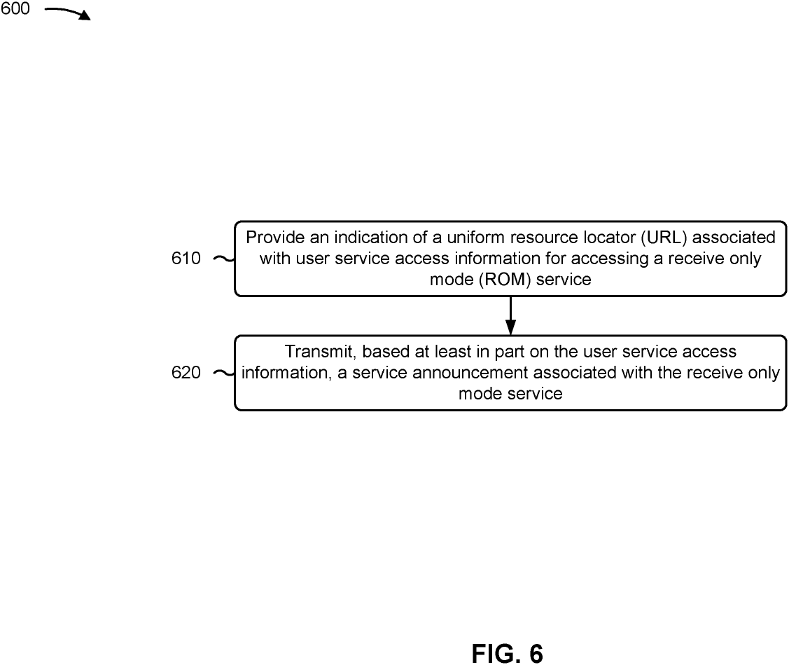

The controller/processor 240 of the base station 110, the controller/processor 280 of the UE 120, and/or any other component(s) of FIG. 2 may perform one or more techniques associated with using a URL indicating parameters for reception of a service announcement for a ROM service, as described in more detail elsewhere herein. In some aspects, the network node described herein is the base station 110, is included in the base station 110, or includes one or more components of the base station 110 shown in FIG. 2. In some examples, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE includes means for obtaining an indication of a URL associated with user service access information for accessing a ROM service; and/or means for receiving, based at least in part on the user service access information, a service announcement associated with the receive only media service. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for providing an indication of a URL associated with user service access information for accessing a ROM service; and/or means for transmitting, based at least in part on the user service access information, a service announcement associated with the receive only media service. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

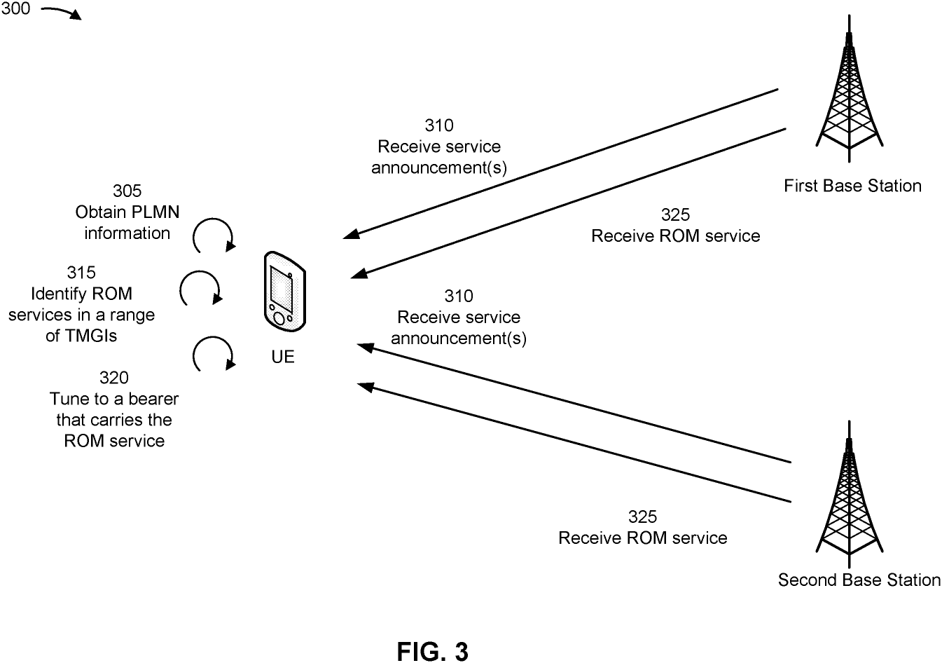

FIG. 3 is a diagram illustrating an example of accessing a ROM service, in accordance with the present disclosure. As shown in FIG. 3, a UE may communicate with one or more base stations (e.g., network nodes) to receive a ROM service, such as a 5G broadcast (e.g., 5G standalone (SA) broadcast) or other multimedia broadcast/multicast service (MBMS), among other examples.

As shown by reference number 305, the UE may obtain Public Land Mobile Network (PLMN) information. The UE may use the PLMN information to identify resources associated with one or more service announcements. In some examples, the UE may obtain the PLMN information via a unicast connection that is previously established with the one or more base stations or an additional network node. The UE may use the PLMN information to discover all available broadcast services (e.g., 5G broadcast services or 5G SA broadcast services, among other examples).

In some networks, the UE may be pre-configured with the PLMN information and associated RAN parameters (e.g., timing and/or resources for service announcements, among other examples), the UE may obtain the PLMN information via an SA configuration in television management object information, the UE may obtain the PLMN information via an SA configuration in an application associated with the ROM service (e.g., via an application interface (API) associated with ROM services, such as an MBMS-API), and/or the UE may obtain the PLMN via a previously discovered ROM service broadcast.

As shown by reference number 310, the UE may receive the one or more service announcements via one or more base stations (e.g., a first base station and/or a second base station). For example, the UE may receive the one or more service announcements based at least in part on the service announcements being broadcasted via a PLMN having at least one broadcast service.

As shown by reference number 315, the UE may identify ROM services in a range of temporary mobile group identity (TMGIs) indicated in the one or more service announcements. The ROM services may include an indication from an emergency alert service to an emergency broadcast media service, a fast redirection from unicast to broadcast, and/or a reference of service guides such as digital video broadcasting-internet (DVB-I), among other examples.

As shown by reference number 320, the UE may tune to a bearer (e.g., a radio bearer) that carries the ROM service. For example, the UE may tune to a bearer that carries the ROM service based at least in part on an indication of one or more time and frequency resources associated with the ROM service in the service announcement.

As shown by reference number 325, the UE may receive the ROM service via one or more base stations (e.g., the first base station and/or the second base station).

The operations described in connection with FIG. 3 may require multiple steps to gain access to the ROM service, and such multiple steps may consume power, computing, communication, and/or network resources. Additionally, or alternatively, the operations may require a unicast connection, which may be unavailable to the UE. In this case, the UE may be unable to gain access to the ROM service.

As indicated above, FIG. 3 is provided as an example. Other examples may differ from what is described with regard to FIG. 3.

In some aspects described herein, a UE may receive an indication of a resource locator (e.g., a URL) that indicates available ROM services (e.g., MBMS SA services), ROM user services, and/or one or more additional parameters. The UE may use the indication of the resource locator to quickly (e.g., with a reduced number of operations and/or communications) find a service announcement associated with a ROM service, the ROM service, and/or a resource of the ROM service.

In some aspects, the UE may receive, and/or be pre-coded with, a data store (e.g., a table) that indicates pre-defined URLs. In some aspects, the UE may receive the data store via an indication from one or more network nodes. The one or more network nodes may generate the data store based at least in part on a registration procedure, in which one or more ROM services register URLs with the one or more network nodes for providing to one or more UEs or other ROM service receivers. The registration procedure may be defined in a 5G media access group (5G-MAG) specification.

In some aspects, a URL may be reserved, which then points to a ROM service (e.g., a 3GPP MBMS ROM service). For example, the URL may be indicated as “mbms://<tmgi>.3gpp.org.” If such a URL is provided, then the service may have one or more standard properties. For example, an assigned TMGI may be in the field <tmgi>, where <tmgi> is up to 12 characters of a hex representation of the TMGI. The service may be a ROM service. The first digit of the TMGI may be set to zero (e.g., to indicate that the service associated with the URL is a ROM service). In some aspects, the TMGI is fewer than 12 characters based at least in part on omitting one or more zeros (e.g., from a beginning portion of the TMGI). For example, the URL may be mbms://901056.3gpp.org&serviceArea=40201&frequency=68616&subCarrierSpacing= 1.25&bandwidth=8, where the TMGI is 901056 (e.g., with only 6 characters).

If the service is a Service Announcement service, the first five digits of the TMGI value may be set to all 0 s (indicating a service announcement service). The TMGI may include a required capability (e.g., ‘23’ as indicated in the Service Announcement of an MBMS User Service Discovery/Announcement Profile 1b as documented in clause L.3 of 3GPP TS 26 346).

If the service is a user service, the first digit may be set to 0 and the second to fifth digits of the TMGI value may not all be set to all 0 (indicating a user service). The User Service Description may include an r16:ROMSvcRfParams child element and signal an E-UTRA Absolute Radio Frequency Channel Number (EARFCN) for subcarrier spacing and bandwidth.

A middle portion of the TMGI may include zero or more (e.g., one or more) &name=value pairs. A suffix may be optional and may include a string “&label=” followed by a universal resources identifier (URI) that includes an identifier of a desired resource and/or a query or fragment part. In some aspects, the TMGI may include one or more value pairs to support locating resources associated with the ROM service. For example, the TMGI may include serviceArea with a value providing a list of service areas that are also present in a userServiceDescription, frequency with a value providing a frequency value of the ROM service that is also present in the userServiceDescription (e.g., coded as EARFCN as defined in 3GPP TS 36.101), subcarrierSpacing with a value providing a subcarrier spacing value of the ROM service that is also present in the userServiceDescription coded subcarrier spacing (Δf) values in 3GPP TS 36.211, bandwidth with a value providing a bandwidth value restricted to be one of specified channel bandwidth values in 3GPP TS 36.104, and/or serviceId with a value in an associated service announcement channel that points to a referenced service, among other examples.

In some aspects, the URL may further indicate a resource that is available. For example, a that is available via the ROM service may be indicated using a URL that follows an example format “label=http://www.example.com/videos/sample.mp4.” Additionally, or alternatively, the UE may indicate a user service that is announced for the ROM service, using an example format “label=”mbms://<tmgi>.3gpp.org.”

As examples, the URL may indicate a service announcement and one or more parameters for receiving the service announcement using one of the following example URLs: “mbms://000000901056.3gpp.org&serviceArea=40201&frequency=68616&subCarrier Spacing=1.25&bandwidth=8” or “mbms://000000901056.3gpp.org&serviceArea=65535,65536&frequency=68616&sub CarrierSpacing=1.25&bandwidth=6.”

As additional examples, the URL may indicate one or more user services and parameters for accessing the user services using one of the following URLs: mbms://000000901056.3gpp.org&serviceArea=40201&frequency=68616&subCarrierS pacing=1.25&bandwidth=8&serviceId=“television-service” (e.g., for a service that is announced through the service announcement channel and has serviceID “television-service”); mbms://000000901056.3gpp.org&serviceArea=40201&frequency=68616&subCarrierS pacing=1.25&bandwidth=8&label=“mbms://OFFFFF901056.3gpp.org” (e.g., for a service that is announced through the service announcement channel and is distributed on TMGI 0FFFFF901056), and/or mbms://000000901056.3gpp.org&serviceArea=40201&frequency=68616&subCarrierS pacing=1.25&bandwidth=8&serviceId= “emergency” (e.g., for a service that is announced through the service announcement channel and has serviceID “emergency”).

In some aspects, the URL may be associated with a user service description (USD) bundle (e.g., a userServiceDescriptionBundle). The USD bundle may include a user service description and a session description protocol (SDP). In some aspects, URL parameters map to a valid USD bundle. For example, a communication protocol may provide mapping from the URL parameters to the valid USD bundle. In this way, the URL parameters may map to the USD and the SDP, which the UE may use to identify an associated user service announcement and/or a user service within the user service announcement, among other examples.

In an example using a 5G broadcast service, a domain name may point to a ROM service, such as mbms://<tmgi>.5g-broadcast.tv. The URL may have one or more properties, parameters, and/or indications as described for other ROM services, the ROM service may be a 5G broadcast service (e.g., as defined in European Telecommunications Standards Institute (ETSI) technical specification (TS) 103 720), and a mobile country code (MCC) value may be set to 901 and a mobile network code (MNC) value may be set to 56 (e.g., such that a final 6 digits of the TMGI are set to 90156). The TMGI and/or URL may include one or more value pairs as described herein.

In some aspects, the UE may receive the URL and identify the URL as being associated with a ROM service (e.g., an MBMS service or a 5G broadcast service, among other examples). The UE may handover (e.g., within the UE) the URL to a ROM URL handler (e.g., an MBMS URL handler). The ROM URL handler may parse the URL to extract one or more parameters for accessing the ROM service. For example, the ROM URL handler may create and/or identify a userServiceDescription bundle and use an addSA API to initiate a service acquisition for an associated service announcement channel. The ROM URL handler may a label or serviceID value to select a user service from a service announcement channel communication (e.g., a service announcement). In this way, communication with an application is further simplified.

In some aspects, a set of pre-defined URLs may be used to indicate information associated with one or more ROM services. For example, a service announcement mbms://5g-broadcast.tv may be equivalent to mbms://000000901056.3gpp.org. Similarly, a service announcement mbms://<subtmgi>.5g-broadcast.tv may be equivalent to mbms://0<subtmgi>901056.3gpp.org.

In some aspects, a registration may be used to define a set of service URLs. For example, mbms://000000901056.3gpp.org&serviceArea=40201&frequency=68616&subCarrierS pacing=1.25&bandwidth=8 and/or Service Announcement mbms://example-usa.tv is equivalent to mbms://000000901056.3gpp.org&serviceArea=65535,65536&frequency=68616&subC arrierSpacing=1.25&bandwidth=6.

Based at least in part on the UE obtaining a resource locator (e.g., URL) that indicates one or more parameters for the UE to identify a service announcement channel, a ROM service, and/or a resource of the ROM service, the UE may conserve power, computing, communication, and/or network resources that may have otherwise been used to perform additional operations to obtain the ROM service and/or the resource of the ROM service. Additionally, or alternatively, a latency may be reduced for establishing the ROM service.

FIG. 4 is a diagram of an example 400 associated with using a URL indicating parameters for reception of a service announcement for a ROM service, in accordance with the present disclosure. As shown in FIG. 4, a network node (e.g., a base station 110, an application server, or one or more devices of a disaggregated RAN) may communicate with a UE (e.g., UE 120). In some aspects, the network node may transmit one or more communications to the UE via one or more intermediate nodes, such as a base station or disaggregated RAN device. In some aspects, the network node and the UE may be part of a wireless network (e.g., wireless network 100). The UE and the network node may have established a wireless connection prior to operations shown in FIG. 4.

As shown by reference number 405, the network node may transmit, and the UE may receive, an indication of a URL associated with user services access information for accessing a ROM service. In some aspects, the UE may receive the indication of the URL via a broadcast or multicast communication, such as a system information block (SIB).

In some aspects, the UE may receive the URL via a network node associated with the service announcement. Additionally, or alternatively, the UE may receive the URL via a network (e.g., a network node) that is independent from the service announcement. For example, the UE may receive the URL from a different network node, a different RAN, and/or a different RAT than a network node that transmits the ROM service data. In some aspects, the UE may obtain the URL via an application plane or an user plane function. For example, the UE may obtain the URL at a previous time or via a different type of network, such as a local area network. Additionally, or alternatively, the UE may identify the URL in a set of URLs that are indicated in a communication protocol.

In some aspects, the URL may indicate one or more parameters for the UE to use to tune to a service announcement channel associated with the ROM service. For example, the URL may include a TMGI that identifies the ROM service (e.g., as available via one or more network nodes), an indication of a domain associated with ROM services, an indication of one or more name and value pairs, a label, a URI that indicates a resource associated with the ROM service, or a query.

In some aspects, the TMGI may indicate one or more parameters for accessing a service announcement channel, the ROM service, and/or a resource of the ROM service. The TMGI may include a multi-character (e.g., up to 12 character) representation (e.g., a multi-character hex representation) of the TMGI and/or a textual representation of the TMGI, a zero as a first character of the TMGI, an indication of whether the TMGI refers to a service announcement service or a user service (e.g., using a subset of the multi-character hex representation, an indication of a capability of the ROM service, and/or an indication of a user service, among other examples). For example, the indication of whether the TMGI refers to a service announcement service or a user service is based at least in part on one or more values of the multi-character hex representation of the TMGI. In some aspects, the one or more values are located in a field from a second to a fifth character of the multi-character hex representation of the TMGI.

In some aspects, based at least in part on the ROM service including a broadcast service, the TMGI may include a value of an MCC and/or an MNC associated with the broadcast service. For example, an end portion of the TMGI may indicate the MCC and the MNC.

In some aspects, the one or more name and value pairs include a service area indication that indicates a set of service areas that are associated with a user service description, a frequency indication that indicates a frequency channel number that is associated with the service announcement, a subcarrier spacing indication that indicates a subcarrier spacing of a service announcement channel that is associated with the service announcement, a bandwidth indication that indicates a bandwidth of the service announcement channel, and/or a service identification that indicates a value of the service announcement channel that is associated with the service announcement. In some aspects, the one or more name and value pairs include a label that indicates an identification of a file distributed via the ROM service, or a user service that is announced on the ROM service. In this way, the UE may obtain the file or establish the user service without first receiving a service announcement. In some aspects, the one or more name and value pairs may be included in the URL outside of the TMGI.

As shown by reference number 410, the UE may identify, based at least in part on the URL, user services access information associated with the ROM service. In some aspects, the UE may identify the URL as being associated with the ROM service (e.g., based at least in part on a first character of the TMGI, among other examples), and identify network resources of a network service announcement channel for receiving a service announcement or for receiving ROM service data or a resource of the ROM service.

As shown by reference number 415, the UE may tune to a service announcement channel associated with the ROM service based at least in part on the user service access information. For example, the UE may configure one or more reception components (e.g., a transmission chain and/or baseband components) to receive a service announcement via the service announcement channel using resources (e.g., time and frequency resources) indicated for reception of the ROM service data. In some aspects, the UE may identify the resources via the URL.

As shown by reference number 420, the UE may receive, and the network node may transmit, the service announcement associated with the ROM. In some aspects, the UE may identify a resource of the network service announcement channel that includes the service announcement. For example, the UE may receive the service announcement based at least in part on the user service access information associated with, or indicated in, the URL.

As shown by reference number 425, the UE may identify a user service or a resource of the user service. For example, the UE may identify the user service or the resource of the user service based at least in part on the service announcement and/or based at least in part on an indication within the URL. In some aspects, the UE may identify the user service or the resource of the user service based at least in part on an indication of the URL independently from (e.g., in absence of) the service announcement.

As shown by reference number 430, the UE may tune to the ROM service. For example, the UE may configure one or more reception components (e.g., a transmission chain and/or baseband components) to receive ROM service data using resources (e.g., time and frequency resources) indicated for reception of the ROM service data. In some aspects, the UE may identify the resources via the service announcement and/or via the URL.

As shown by reference number 435, the UE may receive the ROM service data. For example, the UE may receive an emergency alert, an MBMS service, or a 5G broadcast service, among other examples. In some aspects, the ROM service may include a video and/or audio stream, such as a live event broadcast. In some aspects, the ROM service may be accessible to the UE based at least in part on a registration of the UE with an application server associated with the ROM service. For example, the ROM service data may be encrypted and the UE may use a decryption key (e.g., based at least in part on having authorization to receive the ROM service data) to decrypt the ROM service data.

Based at least in part on the UE obtaining a resource locator (e.g., URL) that indicates one or more parameters for the UE to identify a service announcement channel, a ROM service, and/or a resource of the ROM service, the UE may conserve power, computing, communication, and/or network resources that may have otherwise been used to perform additional operations to obtain the ROM service and/or the resource of the ROM service. Additionally, or alternatively, a latency may be reduced for establishing the ROM service.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with using a URL indicating parameters for reception of a service announcement for a ROM service.

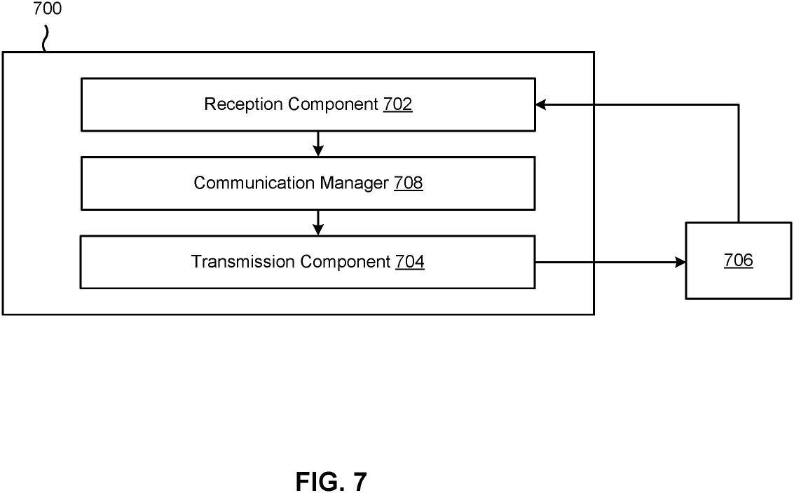

As shown in FIG. 5, in some aspects, process 500 may include obtaining an indication of a URL associated with user service access information for accessing a ROM service (block 510). For example, the UE (e.g., using communication manager 140 and/or reception component 702, depicted in FIG. 7) may obtain an indication of a URL associated with user service access information for accessing a ROM service, as described above.

As further shown in FIG. 5, in some aspects, process 500 may include receiving, based at least in part on the user service access information, a service announcement associated with the receive only media service (block 520). For example, the UE (e.g., using communication manager 140 and/or reception component 702, depicted in FIG. 7) may receive, based at least in part on the user service access information, a service announcement associated with the receive only media service, as described above.

Process 500 may include additional aspects, such as any single aspect or any combination of aspects described below and/or in connection with one or more other processes described elsewhere herein.

In a first aspect, obtaining the URL comprises receiving the URL via a network node associated with the service announcement, receiving the URL via a network that is independent from the service announcement, or identifying the URL in a set of URLs that are indicated in a communication protocol.

In a second aspect, alone or in combination with the first aspect, the URL comprises one or more of a TMGI that identifies the ROM service, an indication of a domain associated with ROM services, an indication of one or more name and value pairs, a label, a URI that indicates a resource associated with the ROM service, or a query.

In a third aspect, alone or in combination with one or more of the first and second aspects, the indication of the TMGI comprises a multi-character hex representation of the TMGI, a textual representation of the TMGI a zero as a first character of the TMGI, an indication of whether the TMGI refers to a service announcement service or a user service, an indication of a capability of the ROM service, or an indication of a user service.

In a fourth aspect, alone or in combination with one or more of the first through third aspects, the indication of whether the TMGI refers to a service announcement service or a user service is based at least in part on values of one or more values of the multi-character hex representation of the TMGI, and the one or more values are located in a field from a second to a fifth character of the multi-character hex representation of the TMGI.

In a fifth aspect, alone or in combination with one or more of the first through fourth aspects, based at least in part on the ROM service including a broadcast service, the TMGI includes a value of one or more of an MCC or an MNC that are associated with the broadcast service.

In a sixth aspect, alone or in combination with one or more of the first through fifth aspects, the one or more name and value pairs include one or more of a service area indication that indicates a set of service areas that are associated with a user service description, a frequency indication that indicates a frequency channel number that is associated with the service announcement, a subcarrier spacing indication that indicates a subcarrier spacing of a service announcement channel that is associated with the service announcement, a bandwidth indication that indicates a bandwidth of the service announcement channel, or a service identification that indicates a value of the service announcement channel that is associated with the service announcement.

In a seventh aspect, alone or in combination with one or more of the first through sixth aspects, the one or more name and value pairs include one or more of a label that indicates an identification of a file distributed via the ROM service, or a user service that is announced on the ROM service.

In an eighth aspect, alone or in combination with one or more of the first through seventh aspects, the ROM service comprises one or more of an MBMS, or a broadcast service.

In a ninth aspect, alone or in combination with one or more of the first through eighth aspects, process 500 includes identifying the URL as being associated with the ROM service, and identifying, based at least in part on the URL, network resources of a network service announcement channel for receiving the service announcement, wherein receiving the service announcement comprises identifying a resource of the network service announcement channel that includes the service announcement.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a network node, in accordance with the present disclosure. Example process 600 is an example where the network node (e.g., e.g., base station 110, an application server, or one or more devices of a disaggregated RAN, such as a CU, a DU, or an RU) performs operations associated with using a URL indicating parameters for reception of a service announcement for a ROM service.

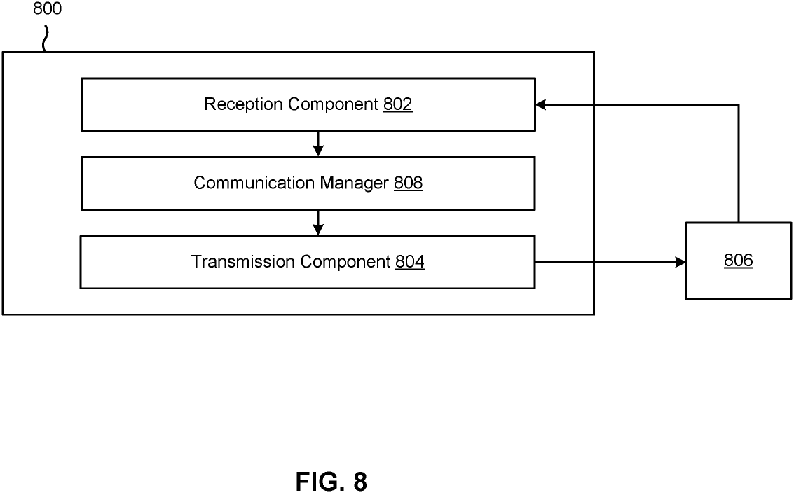

As shown in FIG. 6, in some aspects, process 600 may include providing an indication of a URL associated with user service access information for accessing a ROM service (block 610). For example, the network node (e.g., using communication manager 150 and/or transmission component 804, depicted in FIG. 8) may provide an indication of a URL associated with user service access information for accessing a ROM service, as described above.

As further shown in FIG. 6, in some aspects, process 600 may include transmitting, based at least in part on the user service access information, a service announcement associated with the receive only media service (block 620). For example, the network node (e.g., using communication manager 150 and/or transmission component 804, depicted in FIG. 8) may transmit, based at least in part on the user service access information, a service announcement associated with the receive only media service, as described above.

Process 600 may include additional aspects, such as any single aspect or any combination of aspects described below and/or in connection with one or more other processes described elsewhere herein.

In a first aspect, providing the URL comprises providing the URL via a network node associated with the service announcement, or providing the URL via a network that is independent from the service announcement.

In a second aspect, alone or in combination with the first aspect, the URL comprises one or more of a TMGI that identifies the ROM service, an indication of a domain associated with ROM services, an indication of one or more name and value pairs, a label, a URI that indicates a resource associated with the ROM service, or a query associated with the ROM service.

In a third aspect, alone or in combination with one or more of the first and second aspects, the indication of the TMGI comprises a multi-character hex representation of the TMGI, a textual representation of the TMGI a zero as a first character of the TMGI, an indication of whether the TMGI refers to a service announcement service or a user service, an indication of a capability associated with the ROM service, or an indication of a user service.

In a fourth aspect, alone or in combination with one or more of the first through third aspects, the indication of whether the TMGI refers to a service announcement service or a user service is based at least in part on values of one or more values of the multi-character hex representation of the TMGI, and the one or more values are located in a field from a second to a fifth characters of the multi-character hex representation of the TMGI.

In a fifth aspect, alone or in combination with one or more of the first through fourth aspects, the TMGI includes a value of one or more of an MCC or an MNC that are associated with the broadcast service.

In a sixth aspect, alone or in combination with one or more of the first through fifth aspects, the one or more name and value pairs include one or more of a service area indication that indicates a set of service areas that are associated with a user service description, a frequency indication that indicates a frequency channel number that is associated with the service announcement, a subcarrier spacing indication that indicates a subcarrier spacing of a service announcement channel that is associated with the service announcement, a bandwidth indication that indicates a bandwidth of the service announcement channel, or a service identification that indicates a value of the service announcement channel that is associated with the service announcement.

In a seventh aspect, alone or in combination with one or more of the first through sixth aspects, the one or more name and value pairs include one or more of a label that indicates an identification of a file distributed via the ROM service, or a user service that is announced on the ROM service.

In an eighth aspect, alone or in combination with one or more of the first through seventh aspects, the ROM service comprises one or more of an MBMS, or a broadcast service.

In a ninth aspect, alone or in combination with one or more of the first through eighth aspects, process 600 includes identifying the URL as being associated with the ROM service, and identifying, based at least in part on the URL, network resources of a network service announcement channel for receiving the service announcement, wherein receiving the service announcement comprises identifying a resource of the network service announcement channel that includes the service announcement.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a communication manager 708 (e.g., the communication manager 140).

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 708 and/or the reception component 702 may obtain an indication of a URL associated with user service access information for accessing a ROM service. The reception component 702 may receive, based at least in part on the user service access information, a service announcement associated with the receive only media service.

The communication manager 708 may identify the URL as being associated with the ROM service.

The communication manager 708 may identify, based at least in part on the URL, network resources of a network service announcement channel for receiving the service announcement, wherein receiving the service announcement comprises identifying a resource of the network service announcement channel that includes the service announcement.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808 (e.g., the communication manager 150).

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the network node described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the network node described in connection with FIG. 2. In some aspects, the transmission component 804 may be co-located with the reception component 802 in a transceiver.

The transmission component 804 and/or the communication manager 808 may provide an indication of a URL associated with user service access information for accessing a ROM service. The transmission component 804 may transmit, based at least in part on the user service access information, a service announcement associated with the receive only media service.

The transmission component 804 and/or the communication manager 808 may indicate that the URL is associated with the ROM service.

The transmission component 804 and/or the communication manager 808 may indicate, based at least in part on the URL, network resources of a network service announcement channel for receiving the service announcement, wherein receiving the service announcement comprises identifying a resource of the network service announcement channel that includes the service announcement.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: obtaining an indication of a uniform resource locator (URL) associated with user service access information for accessing a receive only mode (ROM) service; and receiving, based at least in part on the user service access information, a service announcement associated with the ROM service.

Aspect 2: The method of Aspect 1, wherein obtaining the URL comprises: receiving the URL via a network node associated with the service announcement, receiving the URL via a network that is independent from the service announcement, or identifying the URL in a set of URLs that are indicated in a communication protocol.

Aspect 3: The method of any of Aspects 1-2, wherein the URL comprises one or more of: a temporary mobile group identity (TMGI) that identifies the ROM service, an indication of a domain associated with ROM services, an indication of one or more name and value pairs, a label, a universal resource identifier (URI) that indicates a resource associated with the ROM service, or a query.

Aspect 4: The method of Aspect 3, wherein the indication of the TMGI comprises: a multi-character hex representation of the TMGI, a textual representation of the TMGI a zero as a first character of the TMGI, an indication of whether the TMGI refers to a service announcement service or a user service, an indication of a capability of the ROM service, or an indication of a user service.

Aspect 5: The method of Aspect 4, wherein the indication of whether the TMGI refers to a service announcement service or a user service is based at least in part on values of one or more values of the multi-character hex representation of the TMGI, and wherein the one or more values are located in a field from a second to a fifth character of the multi-character hex representation of the TMGI.

Aspect 6: The method of any of Aspects 3-5, wherein, based at least in part on the ROM service including a broadcast service, the TMGI includes a value of one or more of a mobile country code (MCC) or a mobile network code (MNC) that are associated with the broadcast service.

Aspect 7: The method of any of Aspects 3-6, wherein the one or more name and value pairs include one or more of: a service area indication that indicates a set of service areas that are associated with a user service description, a frequency indication that indicates a frequency channel number that is associated with the service announcement, a subcarrier spacing indication that indicates a subcarrier spacing of a service announcement channel that is associated with the service announcement, a bandwidth indication that indicates a bandwidth of the service announcement channel, or a service identification that indicates a value of the service announcement channel that is associated with the service announcement.

Aspect 8: The method of any of Aspects 3-7, wherein the one or more name and value pairs include one or more of: a label that indicates an identification of a file distributed via the ROM service, or a user service that is announced on the ROM service.

Aspect 9: The method of any of Aspects 1-8, wherein the ROM service comprises one or more of: a multimedia broadcast/multicast service (MBMS), or a broadcast service.

Aspect 10: The method of any of Aspects 1-9, further comprising: identifying the URL as being associated with the ROM service, and identifying, based at least in part on the URL, network resources of a network service announcement channel for receiving the service announcement, wherein receiving the service announcement comprises: identifying a resource of the network service announcement channel that includes the service announcement.

Aspect 11: A method of wireless communication performed by a base station, comprising: providing an indication of a uniform resource locator (URL) associated with user service access information for accessing a receive only mode (ROM) service; and transmitting, based at least in part on the user service access information, a service announcement associated with the receive only mode service.

Aspect 12: The method of Aspect 11, wherein providing the URL comprises: providing the URL via a network node associated with the service announcement, or providing the URL via a network that is independent from the service announcement.

Aspect 13: The method of any of Aspects 11-12, wherein the URL comprises one or more of: a temporary mobile group identity (TMGI) that identifies the ROM service, an indication of a domain associated with ROM services, an indication of one or more name and value pairs, a label, a universal resource identifier (URI) that indicates a resource associated with the ROM service, or a query associated with the ROM service.

Aspect 14: The method of Aspect 13, wherein the indication of the TMGI comprises: a multi-character hex representation of the TMGI, a textual representation of the TMGI a zero as a first character of the TMGI, an indication of whether the TMGI refers to a service announcement service or a user service, an indication of a capability associated with the ROM service, or an indication of a user service.

Aspect 15: The method of Aspect 14, wherein the indication of whether the TMGI refers to a service announcement service or a user service is based at least in part on values of one or more values of the multi-character hex representation of the TMGI, and wherein the one or more values are located in a field from a second to a fifth characters of the multi-character hex representation of the TMGI.

Aspect 16: The method of any of Aspects 13-15, wherein, based at least in part on the ROM service including a broadcast service, the TMGI includes a value of one or more of a mobile country code (MCC) or a mobile network code (MNC) that are associated with the broadcast service.

Aspect 17: The method of any of Aspects 13-16, wherein the one or more name and value pairs include one or more of: a service area indication that indicates a set of service areas that are associated with a user service description, a frequency indication that indicates a frequency channel number that is associated with the service announcement, a subcarrier spacing indication that indicates a subcarrier spacing of a service announcement channel that is associated with the service announcement, a bandwidth indication that indicates a bandwidth of the service announcement channel, or a service identification that indicates a value of the service announcement channel that is associated with the service announcement.

Aspect 18: The method of any of Aspects 13-17, wherein the one or more name and value pairs include one or more of: a label that indicates an identification of a file distributed via the ROM service, or a user service that is announced on the ROM service.

Aspect 19: The method of any of Aspects 11-18, wherein the ROM service comprises one or more of: a multimedia broadcast/multicast service (MBMS), or a broadcast service.

Aspect 20: The method of any of Aspects 11-19, further comprising: indicating that the URL is associated with the ROM service, and indicate, based at least in part on the URL, network resources of a network service announcement channel for receiving the service announcement, wherein receiving the service announcement comprises: identifying a resource of the network service announcement channel that includes the service announcement.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
obtain an indication of a uniform resource locator (URL) associated with user service access information for accessing a receive only mode (ROM) service; and
receive, based at least in part on the user service access information, a service announcement associated with the ROM service.

2. The UE of claim 1, wherein the one or more processors, to obtain the URL, are configured to:
receive the URL via a network node associated with the service announcement,
receive the URL via a network that is independent from the service announcement, or
identify the URL in a set of URLs that are indicated in a communication protocol.

3. The UE of claim 1, wherein the URL comprises one or more of:
a temporary mobile group identity (TMGI) that identifies the ROM service,
an indication of a domain associated with ROM services,
an indication of one or more name and value pairs,
a label,
a universal resource identifier (URI) that indicates a resource associated with the ROM service, or
a query.

4. The UE of claim 3, wherein the indication of the TMGI comprises:
a multi-character hex representation of the TMGI,
a textual representation of the TMGI
a zero as a first character of the TMGI,
an indication of whether the TMGI refers to a service announcement service or a user service,
an indication of a capability of the ROM service, or
an indication of a user service.

5. The UE of claim 4, wherein the indication of whether the TMGI refers to a service announcement service or a user service is based at least in part on values of one or more values of the multi-character hex representation of the TMGI, and
wherein the one or more values are located in a field from a second to a fifth character of the multi-character hex representation of the TMGI.

6. The UE of claim 3, wherein, based at least in part on the ROM service including a broadcast service, the TMGI includes a value of one or more of a mobile country code (MCC) or a mobile network code (MNC) that are associated with the broadcast service.

7. The UE of claim 3, wherein the one or more name and value pairs include one or more of:
a service area indication that indicates a set of service areas that are associated with a user service description,
a frequency indication that indicates a frequency channel number that is associated with the service announcement,
a subcarrier spacing indication that indicates a subcarrier spacing of a service announcement channel that is associated with the service announcement,
a bandwidth indication that indicates a bandwidth of the service announcement channel, or
a service identification that indicates a value of the service announcement channel that is associated with the service announcement.

8. The UE of claim 3, wherein the one or more name and value pairs include one or more of:
a label that indicates an identification of a file distributed via the ROM service, or
a user service that is announced on the ROM service.

9. The UE of claim Error! Reference source not found., wherein the ROM service comprises one or more of:
a multimedia broadcast/multicast service (MBMS), or
a broadcast service.

10. The UE of claim 1, wherein the one or more processors are further configured to:
identify the URL as being associated with the ROM service, and
identify, based at least in part on the URL, network resources of a network service announcement channel for receiving the service announcement,
wherein the one or more processors, to receive the service announcement, are configured to:
identify a resource of the network service announcement channel that includes the service announcement.

11. A network node for wireless communication, comprising:
a memory; and
one or more processors, coupled to the memory, configured to:
provide an indication of a uniform resource locator (URL) associated with user service access information for accessing a receive only mode (ROM) service; and
transmit, based at least in part on the user service access information, a service announcement associated with the ROM service.

12. The network node of claim 11, wherein the one or more processors, to provide the URL, are configured to:
provide the URL via a network node associated with the service announcement, or
provide the URL via a network that is independent from the service announcement.

13. The network node of claim 11, wherein the URL comprises one or more of:
a temporary mobile group identity (TMGI) that identifies the ROM service,
an indication of a domain associated with ROM services,
an indication of one or more name and value pairs,
a label,
a universal resource identifier (URI) that indicates a resource associated with the ROM service, or
a query associated with the ROM service.

14. The network node of claim 13, wherein the indication of the TMGI comprises:
a multi-character hex representation of the TMGI,
a textual representation of the TMGI
a zero as a first character of the TMGI,
an indication of whether the TMGI refers to a service announcement service or a user service,
an indication of a capability associated with the ROM service, or
an indication of a user service.

15. The network node of claim 14, wherein the indication of whether the TMGI refers to a service announcement service or a user service is based at least in part on values of one or more values of the multi-character hex representation of the TMGI, and
wherein the one or more values are located in a field from a second to a fifth characters of the multi-character hex representation of the TMGI.

16. The network node of claim 13, wherein, based at least in part on the ROM service including a broadcast service, the TMGI includes a value of one or more of a mobile country code (MCC) or a mobile network code (MNC) that are associated with the broadcast service.

17. The network node of claim 13, wherein the one or more name and value pairs include one or more of:
a service area indication that indicates a set of service areas that are associated with a user service description,
a frequency indication that indicates a frequency channel number that is associated with the service announcement,
a subcarrier spacing indication that indicates a subcarrier spacing of a service announcement channel that is associated with the service announcement,
a bandwidth indication that indicates a bandwidth of the service announcement channel, or
a service identification that indicates a value of the service announcement channel that is associated with the service announcement.

18. The network node of claim 13, wherein the one or more name and value pairs include one or more of:
a label that indicates an identification of a file distributed via the ROM service, or
a user service that is announced on the ROM service.

19. The network node of claim 11, wherein the ROM service comprises one or more of:
a multimedia broadcast/multicast service (MBMS), or
a broadcast service.

20. The network node of claim 11, wherein the one or more processors are further configured to:
indicate that the URL is associated with the ROM service, and
indicate, based at least in part on the URL, network resources of a network service announcement channel for receiving the service announcement,
wherein the one or more processors, to receive the service announcement, are configured to:
identify a resource of the network service announcement channel that includes the service announcement.

21. A method of wireless communication performed by a user equipment (UE), comprising:
obtaining an indication of a uniform resource locator (URL) associated with user service access information for accessing a receive only mode (ROM) service; and
receiving, based at least in part on the user service access information, a service announcement associated with the receive only mode service.

22. The method of claim 21, wherein the URL comprises one or more of:
a temporary mobile group identity (TMGI) that identifies the ROM service,
an indication of a domain associated with ROM services,
an indication of one or more name and value pairs,
a label,
a universal resource identifier (URI) that indicates a resource associated with the ROM service, or
a query.

23. The method of claim 22, wherein the indication of the TMGI comprises:
a multi-character hex representation of the TMGI,
a textual representation of the TMGI
a zero as a first character of the TMGI,
an indication of whether the TMGI refers to a service announcement service or a user service,
an indication of a capability of the ROM service, or
an indication of a user service.

24. The method of claim 23, wherein the indication of whether the TMGI refers to a service announcement service or a user service is based at least in part on values of one or more values of the multi-character hex representation of the TMGI, and
wherein the one or more values are located in a field from a second to a fifth character of the multi-character hex representation of the TMGI.

25. The method of claim 22, wherein, based at least in part on the ROM service including a broadcast service, the TMGI includes a value of one or more of a mobile country code (MCC) or a mobile network code (MNC) that are associated with the broadcast service.

26. A method of wireless communication performed by a network node, comprising:
providing an indication of a uniform resource locator (URL) associated with user service access information for accessing a receive only mode (ROM) service; and
transmitting, based at least in part on the user service access information, a service announcement associated with the receive only mode service.

27. The method of claim 26, wherein the URL comprises one or more of:
a temporary mobile group identity (TMGI) that identifies the ROM service,
an indication of a domain associated with ROM services,
an indication of one or more name and value pairs,
a label,
a universal resource identifier (URI) that indicates a resource associated with the ROM service, or
a query associated with the ROM service.

28. The method of claim 27, wherein the indication of the TMGI comprises:
a multi-character hex representation of the TMGI,
a textual representation of the TMGI
a zero as a first character of the TMGI,
an indication of whether the TMGI refers to a service announcement service or a user service,
an indication of a capability associated with the ROM service, or
an indication of a user service.

29. The method of claim 28, wherein the indication of whether the TMGI refers to a service announcement service or a user service is based at least in part on values of one or more values of the multi-character hex representation of the TMGI, and
wherein the one or more values are located in a field from a second to a fifth characters of the multi-character hex representation of the TMGI.

30. The method of claim 27, wherein, based at least in part on the ROM service including a broadcast service, the TMGI includes a value of one or more of a mobile country code (MCC) or a mobile network code (MNC) that are associated with the broadcast service.
